(19) United States
(12) Patent Application Publication
(10) Pub. No.: US 2015/0050987 A1
(43) Pub. Date: Feb. 19, 2015

(54) SYSTEM AND METHOD FOR DETERMINING CURRENT OR FUTURE USERS OF A VIRTUAL CURRENCY

(71) Applicant: IGT, Las Vegas, NV (US)

(72) Inventors: Vincent C. Huang, Alamo, CA (US); Joseph G. Moss, Danville, CA (US); Woodrow H. Levin, San Francisco, CA (US)

(73) Assignee: IGT, Las Vegas, NV (US)

(21) Appl. No.: 13/965,762

(22) Filed: Aug. 13, 2013

(51) Int. Cl. G06Q 20/06; G07F 17/32

(52) U.S. Cl. CPC G06Q 20/065; G07F 17/3244
USPC 463/25; 705/39

(57) ABSTRACT

Various embodiments of the present disclosure provide a system and method for determining current users of a particular virtual currency or persons likely to use the particular virtual currency in the future (i.e., future users of the virtual currency). More specifically, the system enables a user of a particular virtual currency to employ the system to determine which of the user's connections or contacts are likely to be current users or future users of the virtual currency. This enables the user to quickly and easily identify other current users or (potential) future users of the virtual currency with whom the user may interact using the virtual currency, such as by exchanging the virtual currency with the other user for goods or services or by wagering against the other user on a game of chance or a game of skill using the virtual currency.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

The concept of virtual currency has become increasingly common and more and more accepted in recent years. While virtual currency was originally limited to e-cash transfers or e-payments, there are currently hundreds if not thousands of different types of available virtual currencies. One widely-used virtual currency is Bitcoins, which are accepted in trade by certain merchants and individuals in certain parts of the world. Many organizations offer consumer-oriented loyalty programs in which members accumulate virtual currency in the form of loyalty points that are redeemable for one or more of a variety of rewards, such as real world or virtual goods or services. These loyalty programs, such as frequent flyer programs, credit card reward programs, hotel chain reward programs, retail store reward programs, and the like, give out an estimated $48 billion every year in reward points in the United States alone. Certain casual or social games playable via social networks employ virtual currency in the form of virtual points or credits.

With the large and ever-increasing number of available virtual currencies, it is more likely that a given individual may interact with multiple different currencies each day. For instance, an individual may purchase a cup of coffee using U.S. dollars; exchange 500 credit card reward points for a pair of headphones; purchase a new pair of shoes using a gift card; exchange 50,000 frequent flier miles for a flight to visit friends in Las Vegas; and win 250 virtual credits playing slot games at an online casino.

Because an organization that creates and maintains a virtual currency seeks to control the virtual currency, however, the virtual currency typically does not mirror all aspects of traditional currencies. For example, a user of a virtual currency typically cannot instantly and easily exchange that virtual currency for another virtual currency or convert that virtual currency into a traditional currency (such as U.S. dollars). In another example, the exchange rate of the virtual currency is not set by an exchange, but is instead controlled by the specific organization that provides the specific virtual currency.

One problem that exacerbates the above-identified problems is that it is difficult for users of a particular virtual currency to find one another and interact with one another using the virtual currency. The widespread use of a given virtual currency all but ensures that the users of the virtual currency span a wide geographical area, belong to various demographics, and have varied access to technology. Additionally, the sheer quantity of virtual currencies and the number of virtual currencies owned by each person typically renders it nearly impossible for a given user to know where to begin looking for other users of a particular virtual currency.

A need thus exists for a system that enables users of a particular virtual currency to quickly and easily find other users of that virtual currency to facilitate interaction using that virtual currency.

### SUMMARY

Various embodiments of the present disclosure provide a system and method for determining current users of a particular virtual currency or persons likely to use the particular virtual currency in the future (i.e. future users of the virtual currency). More specifically, the system enables a user of a particular virtual currency to employ the system to determine which of the user's connections or contacts are likely to be current users or future users of the virtual currency. This enables the user to quickly and easily identify other current users or (potential) future users of the virtual currency with whom the user may interact using the virtual currency, such as by exchanging the virtual currency with the other user for goods or services or by wagering against the other user on a game of chance or a game of skill using the virtual currency.

More specifically, in operation of one embodiment, the system receives a request from a user of a particular virtual currency to determine which of the user's connections or contacts are likely to be current users of the virtual currency or future users of the virtual currency (i.e., persons who would begin using the virtual currency if provided the opportunity to do so). The system creates a database including one or more virtual currency user candidates based on the user's connections by: (a) identifying one or more information sources each including a connection or contact list of the user, and (b) adding one or more of the connections or contacts included in one or more of the user's connection or contact lists of the one or more information sources to the database. For each of the candidates in the database, the system collects and stores relevant or designated information about that candidate from the information source(s) including the connection or contact list from which that candidate was added to the database.

For each of the candidates in the database, the system uses the collected information about that candidate to determine a likelihood that that candidate is a current or a future user of the virtual currency. In this embodiment, the system employs a two-step process to do so. First, for each of the candidates in the database, the system determines whether that candidate is part of a known user database for the particular virtual currency. Second, for each of the candidates who are not part of the known user database for the virtual currency, the system employs an algorithm that is tailored to the particular virtual currency to process the collected information about each candidate to determine the likelihood that that particular candidate currently uses the virtual currency or does not currently use the virtual currency, but is likely to start using the virtual currency if provided the opportunity to do so. The system creates a likely user database including any candidates who are known users of the virtual currency or whose likelihood of being a current or a future user of the virtual currency exceeds a designated threshold. For each of the candidates in the likely user database, the system enables the user to contact that candidate to identify whether that candidate is a current user of the virtual currency or would like to begin using the virtual currency.

For each of the candidates in the likely user database who are current users of the virtual currency, the system enables the user to invite that candidate to interact using the virtual currency, such as: (a) to exchange the virtual currency for actual currency (e.g., to give 100 frequent flier miles to the candidate in exchange for $5); (b) to exchange the virtual currency for a different type of virtual currency (e.g., to give the candidate 100 frequent flier miles of one airline in exchange for 100 frequent flier miles of another airline); (c) to exchange the virtual currency for a service (e.g., to pay the candidate 100 frequent flier miles in exchange for a free car wash at the candidate's gas station); (d) to exchange the virtual currency for a virtual good (e.g., to pay the candidate 100 frequent flier miles in exchange for a new outfit for the users avatar); (e) to wager the virtual currency against one another in a game of chance or a game of skill (e.g., to each wager 100 frequent flier miles of an airline on a heads-up Texas Hold'Em tournament); (f) to play with or against one another at a casino in which the virtual currency is used to wager on plays of games of chance or games of skill; and/or (g) to donate the virtual currency to a charity.

In certain embodiments, the system is configured to optimize and learn over time to maximize the system's ability to: (a) correctly identify which candidates are current or future users of a given virtual currency, and (b) cause those candidates who are current or future users of the virtual currency to respond positively to messages sent to those candidates. In other words, the system is configured to recalibrate to improve its ability to identify, target, and contact current and future users of the virtual currency.

The system of the present disclosure thus enables a user of a particular virtual currency to quickly and easily identify those persons who are also likely to be current users (or future users) of the virtual currency, thereby facilitating interaction between users of the virtual currency.

Additional features and advantages are described herein, and will be apparent from, the following Detailed Description and the Figures.

### BRIEF DESCRIPTION OF THE FIGURES

FIG. 1 is a flowchart illustrating an example method of operating one embodiment of the system of the present disclosure.

FIG. 2 is a block diagram of illustrating an example embodiment of the system of the present disclosure interacting with and collecting data from a user's web-based email account and the user's social network account via the Internet

FIG. 3 illustrates a table including a candidate database.

FIG. 4 illustrates a table including collected information associated with each candidate in the candidate database.

FIG. 5 illustrates a table including a likelihood that each candidate is a current member or a future member of a casino's loyalty program.

FIG. 6 illustrates a table including a likely user database of the candidates.

### DETAILED DESCRIPTION

### System and Method for Determining Current or Future Users of a Virtual Currency

Various embodiments of the present disclosure provide a system and method for determining current users of a particular virtual currency or persons likely to use the particular virtual currency in the future (Le, future users of the virtual currency). More specifically, the system enables a user of a particular virtual currency to employ the system to determine which of the user's connections or contacts are likely to be current users or future users of the virtual currency. This enables the user to quickly and easily identify other current users or (potential) future users of the virtual currency with whom the user may interact using the virtual currency, such as by exchanging the virtual currency with the other user for goods or services or by wagering against the other user on a game of chance or a game of skill using the virtual currency.

In certain embodiments, the system includes one or more computing devices, such as one or more central servers, central controllers, or remote hosts, that include one or more central processing units and one or more memory devices (as described in detail below). In various embodiments, the system is configured to maintain and provide a website that is accessible by a user of the system via a user access device, such as a desktop computer, a laptop computer, a tablet computer, a personal digital assistant (PDA), a cell phone (such as a smartphone), and any other suitable computing device. The website includes a system user interface (system UI) that enables users of the system to, after accessing the website using their user access devices, use the system to locate other current users or likely future users of a particular virtual currency.

In other embodiments, the system is operated via one or more applications (commonly referred to as “apps”) downloaded to a user's user access device. In one example, the user opens or launches an application on the user's tablet computing device or smartphone (i.e., the user's user access device), and the application provides the user access to the system UI (which may be the same as the system UI provided on the website or a modified system UI optimized for mobile use). Thus, in these embodiments, the user is not required to navigate to any website to access the system UI and locate other current users or likely future users of a particular virtual currency. In one embodiment, the system enables a user to purchase a “premium” or “upgraded” application that includes additional features or functionality.

In further embodiments, the system is configured to operate within a website maintained by a particular organization that created and that maintains a particular virtual currency. For instance, an airline having a frequent flier miles program enables a member of its frequent flier miles program to access the system UI via the airline's website to locate other current members or likely future members of its frequent flier miles program.

In other embodiments, a website or application of an organization that created and maintains a particular virtual currency has the functionality of the system. In other words, in such embodiments, the functionality of the system is provided by the organization itself via the website or the application of the organization rather than by a separate system.

It should be appreciated that, in various embodiments, the system of the present disclosure is configured to enable users to use user access devices to access the system UI through the Internet or any other suitable data network, such as a mobile communications network, to locate other current users or likely future users of a particular virtual currency.

When a user access device accesses the system UI of the system via a website, the system causes the user access device to display certain images and/or information to the user, and enables the user to make certain inputs using one or more input devices of the user access device. Similarly, if the system is implemented in whole or in part through an application downloaded to the user access device, the application, when opened or launched, causes the user access device to display certain images and/or information to the user, and enables the user to make certain inputs using one or more input devices of the user access device.

For brevity, throughout this application, instead of stating that the system of the present disclosure (or an application thereof) causes the user access device to display images and/or information to the user, the present application often simply states or explains this by stating that the system displays images and/or information to the user. Similarly, for brevity, instead of stating that the system of the present disclosure (or application thereof) causes the user access device to enable the user to make inputs, the present application often states or explains this by stating that the system enables the user to make inputs. It should be appreciated that such statements are for brevity and not meant to limit the scope of the present disclosure.

It should be appreciated that the system of the present disclosure may employ any suitable security measures to protect users' privacy and personal information in accordance with the jurisdiction(s) within which the system is operated. It should also be appreciated that the system of the present disclosure may comply with the policies and/or prohibitions of any virtual currency with which the system is used.

### General System Operation

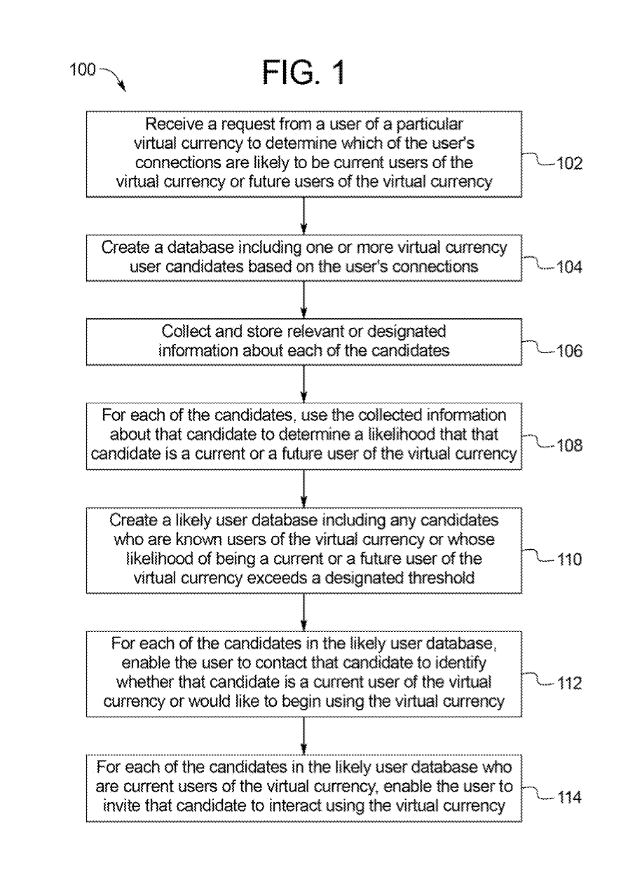

FIG. 1 illustrates a flowchart of an example process or method 100 of operating one embodiment of the system of the present disclosure. In various embodiments, process 100 is represented by a set of instructions stored in one or more memories and executed by one or more processors. Although process 100 is described with reference to the flowchart shown in FIG. 1, it should be appreciated that many other processes of performing the acts associated with this illustrated process may be employed. For example, the order of certain of the illustrated blocks may be changed, certain of the illustrated blocks may be optional, and/or certain of the illustrated blocks may not be employed.

In operation of this embodiment, the system receives a request from a user of a particular virtual currency to determine which of the user's connections or contacts are likely to be current users or future users of the virtual currency (i.e., persons who would begin using the virtual currency if provided the opportunity to do so), as indicated by block 102. The system creates a database including one or more virtual currency user candidates (sometimes referred to herein as “candidates”: for brevity) based on the user's connections, as indicated by block 104. The system collects and stores relevant or designated information about each of the candidates in the database, as indicated by block 106. For each of the candidates in the database, the system uses the collected information about that candidate to determine a likelihood that that candidate is a current or a future user of the virtual currency, as indicated by block 108. The system creates a likely user database including any candidates who are known users of the virtual currency or whose likelihood of being a current or a future user of the virtual currency exceeds a designated threshold, as indicated by block 110. For each of the candidates in the likely user database, the system enables the user to contact that candidate to identify whether that candidate is a current user of the virtual currency or would like to begin using the virtual currency, as indicated by block 112. For each of the candidates in the likely user database who are current users of the virtual currency, the system enables the user to invite that candidate to interact using the virtual currency, as indicated by block 114. Each of the steps of process 100 are described in detail below.

1. Receiving the Request from the User

As generally noted above, the system receives a request from a user of a particular virtual currency (such as via the system UI) to determine which of the user's connections or contacts are likely to be current users or future users of the virtual currency. More specifically, the system receives instructions from the user to collect information from various information sources associated with the user (as described below) to determine which of the user's connections or contacts (if any) are likely to be current or future users of the virtual currency. In other words, in these embodiments, the user actively requests that the system make such determinations.

For example, a member of an airline's frequent flier program who has accumulated a large quantity of miles may want to sell some of those miles to another member of the airline's frequent flier program. In another example, a member of an online casino in which players wager virtual credits to play games of chance or games of skill may want to find a friend with whom to play. In another example, a member of an online casino in which players wager virtual credits to play games of chance or games of skill may want to find another player to whom to sell virtual credits, with whom to trade virtual credits, and/or against whom to wager virtual credits. In another example, an owner of a gift card for a retailer may want to find another person to whom to sell the gift card. In another example, a member of a casino's loyalty program may want to find another member of the casino's loyalty program to whom to sell loyalty points.

In other embodiments, however, the system automatically makes such determinations. In other words, in these embodiments, once the user joins or logs into the system, the system automatically determines which of the user's connections or contacts are likely to be current users or future users of one or more virtual currencies of which the user is a current user. For instance, in one example embodiment, the system does so periodically (such as every week or every month) to keep the user's likely user database(s) (described below) up to date.

### 2. Creating the Database of Candidates

After receiving the request, as generally noted above, the system creates a database including one or more candidates based on the user's connections or contacts. More specifically, the system creates the database of candidates by (a) identifying one or more information sources each including a connection or contact list of the user, and (b) adding one or more of the connections or contacts included in one or more of the user's connection or contact lists of the one or more information sources to the database. The system thus leverages the online and offline connections or contacts of the user to create the database of candidates.

It should be appreciated that the system may obtain the user's connection or contact list(s) from any suitable information source(s), such as (but not limited to): (a) the contact list or address book of the user's email account(s) (such as the user's MICROSOFT OUTLOOK contact list (MICROSOFT and OUTLOOK are registered trademarks of Microsoft Corporation), the user's GMAIL contact list (GMAIL is a registered trademark of Google Inc.), or the user's smartphone contact list); (b) the user's connection list of any social network(s) to which the user subscribes (such as the user's FACEBOOK friends (FACEBOOK is a registered trademark of Facebook, Inc.); the user's TWITTER followers (TWITTER is a registered trademark of Twitter, Inc.); the TWITTER users who follow the user, the user's GOOGLE+ connections (GOOGLE+ is a registered trademark of Google Inc.); the user's PINTEREST connections (PINTEREST is a registered trademark of Pinterest, Inc.); the user's TUMBLR connections (TUMBLR is a registered trademark of Tumblr, Inc.); the user's REDDIT connections (REDDIT is a registered trademark of Reddit, Inc.); the user's LINKEDIN connections (LINKEDIN is a registered trademark of LinkedIn Corp.); and the like); (c) a third party provider (such as RAPLEAF (RAPLEAF is a registered trademark of LiveRamp, Inc.); Pial; or Edo Interactive)); and/or (d) the address book of the user's cell phone.

In certain embodiments, the system automatically identifies the one or more information sources and creates the database including the connection(s) or contact(s) of the connection or contact list(s) of the one or more information source(s). In other embodiments, the system creates the database of candidates using connection(s) or contacts(s) of one or more connection or contact lists of one or more information sources identified by the user. That is, in these embodiments, the user identifies which particular information source(s) the user desires the system to use to create the database of candidates. In further embodiments, the system creates the database of candidates using connection(s) or contact(s) identified by the user. That is, these embodiments, the user herself identifies which particular connection(s) or contact(s) the user desires the system to include in the database of candidates. Put differently, different embodiments of the system afford the user varying degrees of control over which connections or contacts the system will include in the candidate database.

3. Collecting and Storing Information about Each of the Candidates in the Database

Once the system creates the database of candidates, as generally noted above, the system collects and stores relevant or designated information about each of the candidates in the database. More specifically, for each of the candidates, the system collects and stores relevant or designated information about that candidate from the information source(s) including the connection or contact list from which that candidate was added to the database of candidates, Put differently, the system mines the information source(s) for information about the candidate that is considered to influence the identification of that candidate as a current or future user of the virtual currency.

It should be appreciated that the system may collect and store any suitable information about a candidate, such as (but not limited to): (a) the candidate's personal and/or work email address (collected from, for example, the contact list or address book of the user's email account or the address book of the user's cell phone); (b) the candidate's mailing address (collected from, for example, the contact list or address book of the users email account or the address book of the user's cell phone); (c) the candidate's work address (collected from, for example, the contact list or address book of the user's email account or the address book of the user's cell phone); (d) the candidate's home phone number, work phone number, and/or cell phone number (collected from, for example, the contact list or address book of the user's email account or the address book of the user's cell phone); (e) the candidate's job title (collected from, for example, the contact list or address book of the user's email account, the address book of the user's cell phone, the candidate's LINKEDIN profile, the candidate's FACEBOOK profile, or the candidate's GOOGLE+ profile); (f) the FACEBOOK pages “Liked” by the candidate (collected from the candidate's FACEBOOK profile); (g) the candidate's TWITTER “hashtag” usage (collected from TWITTER); (h) the candidate's “Check-In” data (collected from, for example, the candidate's FACEBOOK profile); (i) the candidate's travel information (collected from, for example, the candidate's TRIPIT profile (TRIPIT is a registered trademark of Tripit, Inc.)); (j) any suitable information about the candidate collected by a third party provider (collected directly from the third party provider); (k) the pages “pinned” to the candidate's PINTEREST page (collected from the candidate's PINTEREST page); (l) the REDDIT threads the candidate follows (collected from the candidate's REDDIT profile); (m) the candidate's TWITTER interest graph; and/or (n) an interest graph from any social network to which the candidate belongs.

In certain instances, a particular candidate may be included in the connection or contact list of a plurality of different information sources. In these instances, in certain embodiments, the system collects and stores information about the candidate from each of the information sources. For example, a particular candidate is included in the user's email address book and is also a connection of the user on LINKEDIN. In this example, the system: (a) collects and stores the candidate's personal email address and home address from the user's email address book, and (b) collects and stores the candidate's job title and job description from the candidate's LINKEDIN profile. That is, in these embodiments, the system employs each available information source to collect information about the candidate that is considered to influence the identification of that candidate as a virtual currency holder.

In one embodiment, the system provides an alert to the user if collected information that is supposed to match from information source to information source does not match. For example, the system alerts the user if a candidate's cell phone number stored in the user's email address book does not match the candidate's cell phone number stored in the address book of the user's cell phone.

4. Determining the Likelihood that Each Candidate is a Current or a Future User of the Virtual Currency

Once the system collects information about each of the candidates in the database, as generally noted above, the system uses the collected information about that candidate to determine a likelihood that that candidate is a current or a future user of the virtual currency. In certain embodiments, the system employs a two-step process to do so. First, for each of the candidates in the database, the system determines whether that candidate is part of a known user database for the particular virtual currency. Second, for each of the candidates who are not part of the known user database for the virtual currency, the system employs an algorithm that is tailored to the particular virtual currency to process the collected information about each candidate to determine the likelihood that that particular candidate currently uses the virtual currency or does not currently use the virtual currency, but is likely to start using the virtual currency if provided the opportunity to do so. In one embodiment, the system does not use the algorithm in association with candidates who are known users of the virtual currency. In other embodiments, however, the system does do so to collect additional data to use for system optimization (described below).

It should be appreciated that, in other embodiments, the system does not employ the step of determining whether each candidate is part of a known user database for the particular virtual currency.

Various embodiments of the system include algorithms with different weightings for different virtual currencies (i.e., which information is deemed more important with respect to different virtual currencies) are described below.

One example of virtual currency is frequent flier miles provided by an airline. In this example, the algorithm places greater weight on (i.e., predicts that the candidate is more likely to be a current or a future user of the airline's frequent flier miles): (a) the candidate's home address and/or business address being within a designated proximity of the airline's hub; (b) the candidate's travel information indicating that the candidate travels for business (e.g., that the candidates takes one trip per week); (c) the candidate's “Check-In” data including frequent and diverse “Check-Ins” in a variety of different geographic regions; (d) the candidate having “Liked” the airline's FACEBOOK page; (e) the candidate's TWITTER data including hashtag searches of the airline; (f) the candidate's LINKEDIN profile including the candidate's job title being related to travel or likely to include travel; and (g) the density and distribution of location data (such as longitude/latitude data) in Exchangeable image file format (Exif) within photos of the candidate (such as photos uploaded to FACEBOOK or TWITTER).

Another example of virtual currency is loyalty points provided by a casino's loyalty program. In this example, the algorithm places greater weight on (i.e., makes it more likely that the candidate is a current or a future member of the casino's loyalty program): (a) the candidate's home address and/or business address being within a designated proximity of the casino; (b) the candidate's “Check-In” data including “Check-Ins” at the casino, the casino's hotel, and/or any of the casino's restaurants; (c) the candidate having “Liked” the casino's FACEBOOK page; (d) the candidate's TWITTER data including hashtag searches of the casino; and (e) the candidate's travel information indicating frequent trips near the casino.

Another example of virtual currency is reward points provided by a credit card company. In this example, the algorithm places greater weight on (i.e., makes it more likely that the candidate is a current or a future user of the credit card company's reward points): (a) the candidate's “Check-In” data including “Check-Ins” at preferred partners of the credit card company; (b) the candidate having “Liked” the casino's FACEBOOK page; (c) the candidate's TWITTER data including hashtag searches of the credit card company; (d) the candidate's following of the credit card company on TWITTER; (e) calls to the credit card company's phone number from third party resources like Edo Interactive; and (f) linkages between a social network and the credit card company (e.g., a linkage between FOURSQUARE (FOURSQUARE is a registered trademark of Foursquare Labs, Inc.) and AMERICAN EXPRESS (AMERICAN EXPRESS is a registered trademark of American Express Marketing & Development Corp.)).

Another example of virtual currency is virtual credits used to play a casual game on, for example, a social network. In this example, the algorithm places greater weight on (i.e., makes it more likely that the candidate is a current or a future user of the virtual credits): (a) the candidate's having a high score on a casual or social game on the social network; (b) the candidate's participation in one or more casual or social games on the social network; (c) the candidate having “Liked” one or more casual or social games employing the virtual credits; (d) the candidate's TWITTER data including hashtag searches of one or more casual or social games; and e) the candidate's having friends who are users of the virtual credits and/or who play one or more casual or social games.

Another example of virtual currency is rewards points provided by a retailer. In this example, the algorithm places greater weight on (i.e., predicts that the candidate is more likely to be a current or a future user of the retailer's reward points): (a) the candidate's home address being within a designated proximity of the retailer's brick and mortar store; (b) the candidate's “Check-In” data including frequent “Check-Ins” at the retailer's brick and mortar store; (c) the candidate having “Liked” the retailer's FACEBOOK page; (d) the candidate having posted purchases from the retailer on the candidate's FACEBOOK News Feed; (e) the candidate's TWITTER data including hashtag searches of the retailer; (f) the candidate's following of the retailer on TWITTER; (g) the candidate's “pinning” of one of the retailer's products on PINTEREST; and (h) the candidates reviews on the internet, such as the candidate's YELP reviews (YELP is a registered trademark of Yelp Inc.).

In certain embodiments, the system cross-references certain collected information across various information sources, which enables the system to “guess” identify, preferences, and signals to incorporate into the algorithm. For instance, the system cross references the TWITTER handle of a candidate with other information sources (because the candidate has a higher propensity of using that same identifying handle within other information sources (such as websites)).

It should be appreciated that any suitable algorithm may be employed, and that the algorithm may weight any suitable information more or less heavily and consider any suitable information. It should also be appreciated that different algorithms may be employed in association with different virtual currencies.

### 5. Creating the Likely User Database

Once the system has determined the likelihood that each candidate is a current or a future user of the virtual currency (if necessary), as generally noted above, the system creates a likely user database including any candidates who are known users of the virtual currency or whose likelihood of being a current or a future user of the virtual currency exceeds a designated threshold. The designated threshold is set such that the likely user database includes the candidates most likely to be current or future users of the virtual currency and excludes the candidates who are not likely to be current or future users of the virtual currency.

It should be appreciated that the designated threshold may be set to any suitable value.

### 6. Enabling the User to Contact the Candidates of the Likely User Database

Once the system creates the likely user database of candidates, as generally noted above, for each of the candidates in the likely user database, the system enables the user to contact that candidate to identify whether that candidate is a current user of the virtual currency or would like to begin using the virtual currency. Put differently, after targeting candidates who are likely to be current or future users of the virtual currency, the system enables the user to personally reach out to those candidates to determine whether; (a) the candidate currently uses the virtual currency, or (b) the candidate does not currently use the virtual currency, but would like to use the virtual currency in the future. In these embodiments, the user makes the decision whether to reach out to the candidate(s), though in other embodiments the system automatically does so either on behalf of the user, on behalf of the virtual currency provider, or both.

It should be appreciated that the system enables the user to contact a candidate in the likely user database in any suitable manner, such as via: (a) an email message; (b) a text message; (c) an instant message; (d) a pre-recorded phone call; (e) a FACEBOOK message; (f) a “TWEET” (TWEET is a registered trademark of Twitter, Inc.); (g) an IMESSAGE (IMESSAGE is a registered trademark of Apple Inc.); (h) a message within an app (such as LINE, WHATSAPP (WHATSAPP is a registered trademark of WhatsApp Inc.), or GROUPME (GROUPME is a registered trademark of Groupme Inc.); and/or (i) any other form of electronic communication.

In certain embodiments, the message(s) are system-generated. In certain of these embodiments, the system enables the user to select the message to send a particular candidate in the likely user database from a bank of predetermined messages and does not enable the user to generate the user's own messages. In other such embodiments, the system determines which message to send to a particular candidate.

In various embodiments, the system employs A/Bin testing (also referred to as A/B testing or “split” testing) to identify an optimal message or a set of optimal messages. In other words, the system employs A/B/n testing in these embodiments to determine which message(s), when sent to a candidate, are most likely to generate a positive response from the candidate. In one example, the system does so by sending a first message to a first set of the candidates in the likely user database selected by the user and by sending a second different message to a second different set of the candidates in the likely user database selected by the user. The system tracks the candidates' responses and determines which of the messages is more likely to generate a positive response from a candidate. In this example, the system replaces the message that is less likely to generate a positive response from a candidate with another message going forward, repeats the process until the system determines an optimal message or group of messages.

In other embodiments, the system enables the user to create personal messages and send those messages to candidates in the likely user database. In further embodiments, the system enables the player to either choose a message from a bank of predetermined messages to send to a candidate in the likely user database or to create a personal message to send to the candidate.

7. Enabling the User to Invite Candidates Who Currently Use the Virtual Currency to. Interact

After the system enables the user to contact to the candidate(s) of the likely user database, as generally noted above, for each of the candidates in the likely user database who currently use the virtual currency, the system enables the user to invite that candidate to interact using the virtual currency, such as by exchanging or wagering the virtual currency. It should be appreciated that the system may enable the user to invite a candidate to interact using the virtual currency in any of a plurality of different manners, such as: (a) to exchange the virtual currency for actual currency (e.g., to give 100 frequent flier miles to the candidate in exchange for $5); (b) to exchange the virtual currency for a different type of virtual currency (e.g., to give the candidate 100 frequent flier miles of one airline in exchange for 100 frequent flier miles of another airline); (c) to exchange the virtual currency for a service (e.g., to pay the candidate 100 frequent flier miles in exchange for a free car wash at the candidate's gas station); (d) to exchange the virtual currency for a virtual good (e.g., to pay the candidate 100 frequent flier miles in exchange for a new outfit for the user's avatar): (e) to wager the virtual currency against one another in a game of chance or a game of skill (e.g., to each wager 100 frequent flier miles of an airline on a heads-up Texas Hold'Em tournament); (f) to play with or against one another at a casino in which the virtual currency is used to wager on plays of games of chance or games of skill; and/or (g) to donate the virtual currency to a charity.

It should be appreciated that the system enables the user to contact a candidate in the likely user database in any suitable manner, such as via: (a) an email message; (b) a text message; (c) an instant message; (d) a pre-recorded phone call; (e) a FACEBOOK message; (f) a “TWEET” (TWEET is a registered trademark of Twitter, Inc.); (g) an IMESSAGE (IMESSAGE is a registered trademark of Apple Inc.); (h) a message within an app (such as LINE, WHATSAPP (WHATSAPP is a registered trademark of WhatsApp Inc.), or GROUPME (GROUPME is a registered trademark of Groupme Inc.); and/or (i) any other form of electronic communication.

### Example Embodiment

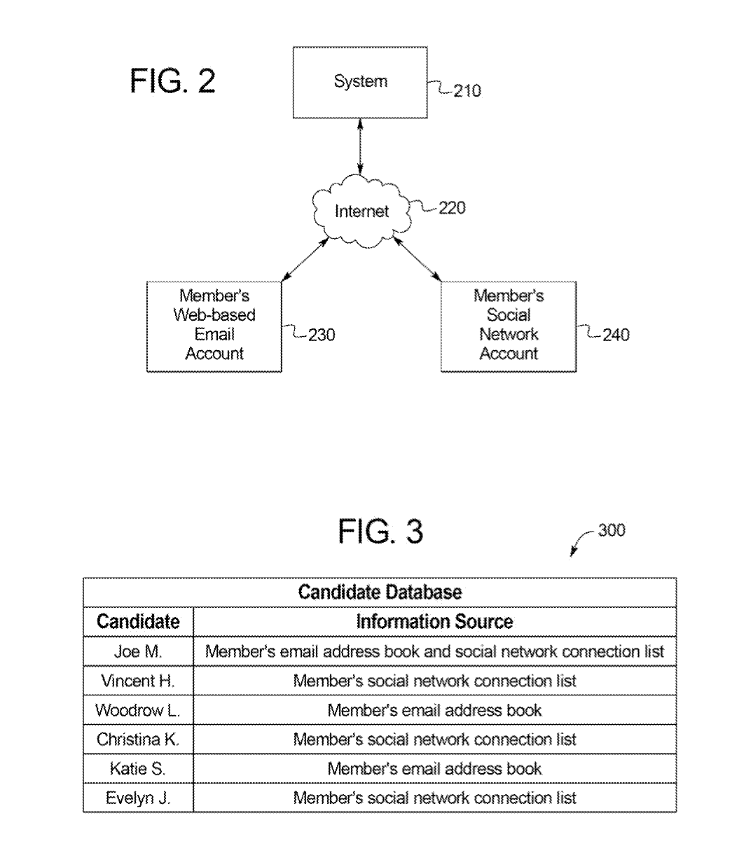

One example embodiment of the system in operation is described below in accordance with FIGS. 2, 3, 4, 5, and 6. In this example embodiment, the system 210 receives a request from a member of a casino's loyalty program to determine which of the member's connections are likely to be current or future users of the casino's loyalty program. After receiving the request, the system 210 creates a database of candidates by: (a) identifying two information sources each including a connection or contact list of the member, and (b) adding the connections or contacts included in the member's two connection or contact lists to the database. More specifically, in this example embodiment and as shown in FIG. 2, the system 210: (a) identifies the member's web-based email account 230 and the member's social network account 240; (b) accesses the contact list of the member's web-based email account 230 and the social network connection list of the member's social network account 240 via a data network, such as the Internet 220; and (c) adds each contact in the contact list of the member's web-based email account 230 and each connection in the social network connection list of the member's social network account 240 to the database.

As shown in FIG. 3, table 300 includes the candidate database and identifies each candidate and the information source(s) from which the candidate was added to the candidate database. In this example embodiment: (a) Candidate Joe M. was added to the candidate database from the contact list of the member's web-based email account and from the member's social network connection list, (b) Candidate Vincent H. was added to the candidate database from the member's social network connection list, (c) Candidate Woodrow L. was added to the candidate database from the contact list of the member's web-based email account, (d) Candidate Christina K. was added to the candidate database from the member's social network connection list, (e) Candidate Katie S. was added to the candidate database from the contact list of the member's web-based email account, and (f) Candidate Evelyn J. was added to the candidate database from the member's social network connection list.

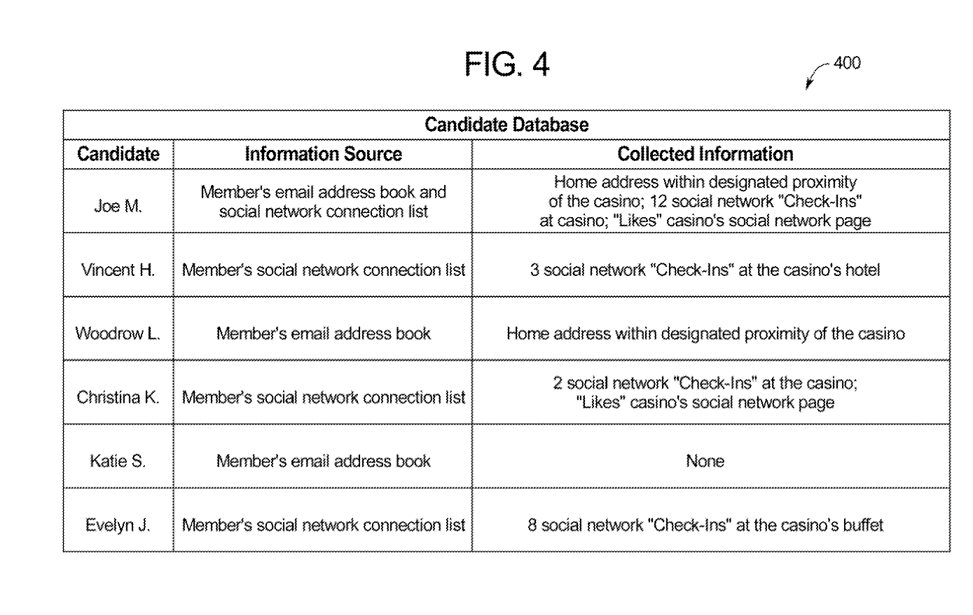

After creating the database of candidates, the system 210 collects and stores information about each candidate from the information source(s) including the connection or contact list from which that candidate was added to the database of candidates. As shown in FIG. 4, table 400 includes the collected information for each of the candidates of the database. More specifically, the system 210 determined: (a) that Candidate Joe M.'s home address is within a designated proximity of the casino, that Candidate Joe M. has “Checked-In” at the casino twelve times on the social network, and that Candidate Joe M. has “Liked” the casino's social network page; (b) that Candidate Vincent H. has “Checked-In” at the casino's hotel three times on the social network; (c) that Candidate Woodrow L.'s home address is within the designated proximity of the casino; (d) that Candidate Christina K. has “Checked-In” at the casino two times on the social network and has “Liked” the casino's social network page; (e) no relevant information regarding Candidate Katie S; and (f) that Candidate Evelyn J. has “Checked-In” at the casino's buffet eight times on the social network.

The system 210 determines that none of the candidates are part of a known user database including a list of known casino loyalty program members. Thus, the system uses the collected information about that candidate and a weighted algorithm associated with the casino's loyalty program to determine a likelihood that that candidate is a current or a future member of the casino's loyalty program. In this example embodiment, the algorithm places a greater weight on (i.e., makes it more likely that the candidate is a current or a future member of the casino's loyalty program): (a) the candidate's home address being within a designated proximity of the casino; (b) the candidate's social network “Check-In” data including “Check-Ins” at the casino, the casino's hotel, and/or any of the casino's restaurants; and (c) the candidate having “Liked” the casino's social network page.

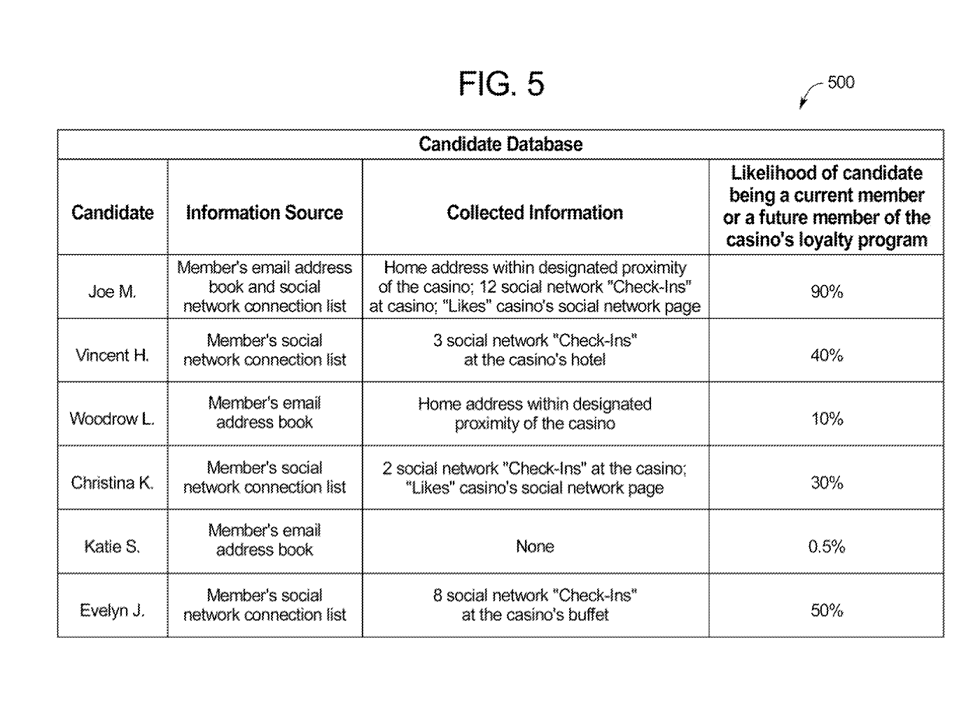

As shown in FIG. 5, table 500 includes the determined likelihood that each candidate is a current or a future member of the casino's loyalty program. More specifically, in this example embodiment, the system 210 determined that: (a) it is 90% likely that Candidate Joe M. is a current or future member of the casino's loyalty program, (b) it is 40% likely that Candidate Vincent H. is a current or future member of the casino's loyalty program, (c) it is 10% likely that Candidate Woodrow L. is a current or future member of the casino's loyalty program, (d) it is 30% likely that Candidate Christina K. is a current or future member of the casino's loyalty program, (e) it is 0.5% likely that Candidate Katie S. is a current or future member of the casino's loyalty program, and (f) it is 50% likely that Candidate Evelyn J. is a current or future member of the casino's loyalty program.

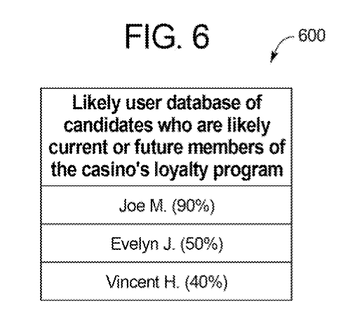

Once the system 210 has determined the likelihood that each candidate is a current or a future member of the casino's loyalty program, the system 210 creates a likely user database including any candidates whose likelihood of being a current or a future member of the casino's loyalty program at least meets a designated threshold, which is 40% in this example embodiment. As shown in FIG. 6, table 600 includes the likely user database of candidates who are likely current or future members of the casino's loyalty program. More specifically, the system 210 determined that Candidates Joe M. (90%), Evelyn J. (50%), and Vincent H. (40%) are likely current or future members of the casino's loyalty program.

Once the system 210 creates the likely user database of candidates, for each of the candidates in the likely user database, the system 210 enables the member to contact that candidate to identify whether that candidate is a current member of the casino's loyalty program or would like to become a member of the casino's loyalty program. After the system 210 enables the user to contact to the candidate(s) in the likely user database, for each of the candidates in the likely user database who are current members of the casino's loyalty program, the system 210 enables the member to invite that candidate to interact using the casino's loyalty points.

### System Optimization

In certain embodiments, the system is configured to optimize and learn over time to maximize the system's ability to: (a) correctly identify which candidates are current or future users of a given virtual currency, and (b) cause those candidates who are current or future users of the virtual currency to respond positively to messages sent to those candidates. In other words, the system is configured to recalibrate to improve its ability to identify, target, and contact current and future users of the virtual currency.

More specifically, in various embodiments, the system re-assesses the algorithm and recalibrates the weightings based on the success or failure of the system in correctly identifying which candidates are current or future users of a given virtual currency. For instance, in an example in which the virtual currency is airline frequent flier miles initially, the algorithm may give more weight to the candidate's home address being within a designated proximity of the airline's hub than it does to the candidate's “Liking” the airline's FACEBOOK page. However, over time, the system determines that the location of the candidate's home address in relation to the airline's hub has little correlation with the candidate being a current or a future user of the airline's frequent flier miles, and that the candidate's “Liking” the airline's FACEBOOK page has a high correlation with the candidate being a current or a future user of the airline's frequent flier miles. Accordingly, in this example, the system removes the proximity of the candidate's home address to the airline's hub from the algorithm and increases the weight given to the candidate's “Liking” the airline's FACEBOOK page.

In other embodiments, as explained above with respect to A/B/n testing, the system re-assesses the messages the system provides to candidates based on the success of those messages generating positive responses. The system removes less successful messages in favor of more successful messages.

In certain embodiments, the algorithm's methodology changes to better indicate which candidates are users of a particular virtual currency.

### Computing Device(s)

It should be appreciated that the embodiments of the system described herein may be implemented in accordance with or in conjunction with one or more of a variety of different types of systems, such as, but not limited to, those described below.

The present disclosure contemplates a variety of different systems each having one or more of a plurality of different features, attributes, or characteristics. It should be appreciated that a system as used herein refers to various configurations of: (a) one or more central servers, central controllers, or remote hosts; and/or (b) one or more personal devices, such as desktop computers, laptop computers, tablet computers or computing devices, personal digital assistants (PDAs), mobile telephones such as smartphones, and other mobile computing devices.

Thus, in various embodiments, the system of the present disclosure includes: (a) one or more personal devices in combination with one or more central servers, central controllers, or remote hosts; (b) a single personal device; (c) a plurality of personal devices in combination with one another; (d) a single central server, central controller, or remote host; and/or (e) a plurality of central servers, central controllers, or remote hosts in combination with one another.

For brevity and clarity, unless specifically stated otherwise, “personal device” as used herein represents one personal device or a plurality of personal devices, and “central server, central controller, or remote host” as used herein represents one central server, central controller, or remote host or a plurality of central servers, central controllers, or remote hosts.

As noted above, in various embodiments, the system includes a personal device in combination with a central server, central controller, or remote host. In such embodiments, the personal device is configured to communicate with the central server, central controller, or remote host through a data network or remote communication link. In certain such embodiments, the personal device is configured to communicate with another personal device through the same data network or remote communication link or through a different data network or remote communication link.

In certain embodiments in which the system includes a personal device in combination with a central server, central controller, or remote host, the central server, central controller, or remote host is any suitable computing device (such as a server) that includes at least one processor and at least one memory device or storage device. The personal device includes at least one personal device processor configured to transmit and receive data or signals representing events, messages, commands, or any other suitable information between the personal device and the central server, central controller, or remote host. The at least one processor of that personal device is configured to execute the events, messages, or commands represented by such data or signals in conjunction with the operation of the personal device. Moreover, the at least one processor of the central server, central controller, or remote host is configured to transmit and receive data or signals representing events, messages, commands, or any other suitable information between the central server, central controller, or remote host and the personal device. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the personal device. It should be further appreciated that one, more, or each of the functions of the at least one processor of the personal device may be performed by the at least one processor of the central server, central controller, or remote host.

In certain embodiments in which the gaming system includes: (a) a personal device configured to communicate with a central server, central controller, or remote host through a data network; and/or (b) a plurality of personal devices configured to communicate with one another through a data network, the data network is a local area network (LAN) in which the personal devices are located substantially proximate to one another and/or the central server, central controller, or remote host. In one example, the personal devices and the central server, central controller, or remote host are located in a gaming establishment or a portion of a gaming establishment.

In other embodiments in which the gaming system includes: (a) a personal device configured to communicate with a central server, central controller, or remote host through a data network; and/or (b) a plurality of personal devices configured to communicate with one another through a data network, the data network is a wide area network (WAN) in which one or more of the personal devices are not necessarily located substantially proximate to another one of the personal devices and/or the central server, central controller, or remote host. It should be appreciated that systems in which the data network is a WAN are substantially identical to systems in which the data network is a LAN, though the quantity of personal devices in such systems may vary relative to one another.

In further embodiments in which the system includes: (a) a personal device configured to communicate with a central server, central controller, or remote host through a data network; and/or (b) a plurality of personal devices configured to communicate with one another through a data network, the data network is an internet or an intranet.

It should be appreciated that the central server, central controller, or remote host and the personal device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
(a) causing at least one processor to execute a plurality of instructions stored in at least one memory device to operate with at least one input device to receive a request from a user of a virtual currency to determine one or more other users of the virtual currency;
(b) causing the at least one processor to execute the plurality of instructions to create a database of at least one candidate based on one or more connections of the user;
(c) for each of the at least one candidate in the database, causing the at least one processor to execute the plurality of instructions to collect information associated with said candidate;
(d) for each of the at least one candidate in the database, causing the at least one processor to execute the plurality of instructions to use the collected information associated with said candidate to determine a likelihood that said candidate is a current user of the virtual currency;
(e) causing the at least one processor to execute the plurality of instructions to create a likely user database including any of the at least one candidate whose likelihood of being a current user of the virtual currency exceeds a designated threshold;
(f) for each candidate in the likely user database, enabling the user to contact said candidate.

2. The method of claim 1, which includes causing the at least one processor to execute the plurality of instructions to create the database of the at least one candidate based on the one or more connections of the user by: (i) identifying at least one information source, each said information source including a list of connections of the user; and (ii) for each said information source, adding at least one of the connections in the list of connections of the user of said information source to the database.

3. The method of claim 1, which includes, for each of the at least one candidate in the database, causing the at least one processor to execute the plurality of instructions to use the collected information associated with said candidate to determine a likelihood that said candidate is a current user of the virtual currency by:
(1) determining that said candidate is a current user of the virtual currency if said candidate is included in a known user database associated with the virtual currency; and
(2) if said candidate is not included in the known user database associated with the virtual currency, using an algorithm associated with the virtual currency to determine the likelihood that said candidate is a current user of the virtual currency.

4. The method of claim 1, wherein, for each of the at least one candidate in the database, causing the at least one processor to execute the plurality of instructions to use the collected information associated with said candidate to determine a likelihood that said candidate is a current user of the virtual currency includes causing the at least one processor to execute the plurality of instructions to use an algorithm associated with the virtual currency to determine the likelihood that said candidate is a current user of the virtual currency.

5. The method of claim 4, wherein the algorithm is a weighted algorithm.

6. The method of claim 5, which includes causing the at least one processor to execute the plurality of instructions to recalibrate the weighted algorithm based at least in part on whether any candidates in the likely user database are current users of the virtual currency.

7. The method of claim 4, wherein the algorithm employed for another different virtual currency is different than the algorithm employed for the virtual currency.

8. The method of claim 1, which includes, for each of the at least one candidate in the database, causing the at least one processor to execute the plurality of instructions to use the collected information associated with said candidate and an algorithm associated with the virtual currency to determine a likelihood that said candidate is a future user of the virtual currency.

9. The method of claim 8, which includes causing the at least one processor to execute the plurality of instructions to add to likely user database list any of the at least one candidate whose likelihood of being a future user of the virtual currency exceeds the designated threshold.

10. The method of claim 1, which includes enabling the user to invite each candidate who is a current user of the virtual currency to interact using the virtual currency.

11. The method of claim 10, wherein said interaction using the virtual currency includes wagering on a game of chance or a game of skill.

12. The method of claim 1, which is provided through a data network.

13. The method of claim 10, wherein the data network is an internet.

14. A system comprising:
at least one controller configured to:
(a) receive a request from a user of a virtual currency to determine one or more other users of the virtual currency;
(b) create a database of at least one candidate based on one or more connections of the user;
(c) for each of the at least one candidate in the database, collect information associated with said candidate;
(d) for each of the at least one candidate in the database, use the collected information associated with said candidate to determine a likelihood that said candidate is a current user of the virtual currency;
(e) create a likely user database including any of the at least one candidate whose likelihood of being a current user of the virtual currency exceeds a designated threshold;
(f) for each candidate in the likely user database, enable the user to contact said candidate.

15. The system of claim 14, wherein the controller is configured to create the database of the at least one candidate based on the one or more connections of the user by: (i) identifying at least one information source, each said information source including a list of connections of the user; and (ii) for each said information source, adding at least one of the connections in the list of connections of the user of said information source to the database.

16. The system of claim 14, wherein the controller is configured to for each of the at least one candidate in the database, use the collected information associated with said candidate to determine a likelihood that said candidate is a current user of the virtual currency by:
(1) determining that said candidate is a current user of the virtual currency if said candidate is included in a known user database associated with the virtual currency; and
(2) if said candidate is not included in the known user database associated with the virtual currency, using an algorithm associated with the virtual currency to determine the likelihood that said candidate is a current user of the virtual currency.

17. The system of claim 14, wherein, for each of the at least one candidate in the database, the controller is configured to use the collected information associated with said candidate to determine a likelihood that said candidate is a current user of the virtual currency by using an algorithm associated with the virtual currency to determine the likelihood that said candidate is a current user of the virtual currency.

18. The system of claim 17, wherein the algorithm is a weighted algorithm.

19. The system of claim 18, wherein the controller is configured to recalibrate the weighted algorithm based at least in part on whether any candidates in the likely user database are current users of the virtual currency.

20. The system of claim 17, wherein the algorithm employed for another different virtual currency is different than the algorithm employed for the virtual currency.

21. The system of claim 14, wherein the controller is configured to, for each of the at least one candidate in the database, use the collected information associated with said candidate and an algorithm associated with the virtual currency to determine a likelihood that said candidate is a future user of the virtual currency.

22. The system of claim 21, wherein the controller is configured to add to likely user database list any of the at least one candidate whose likelihood of being a future user of the virtual currency exceeds the designated threshold.

23. The system of claim 14, which includes enabling the user to invite each candidate who is a current user of the virtual currency to interact using the virtual currency.

24. The system of claim 23, wherein said interaction using the virtual currency includes wagering on a game of chance or a game of skill.
